(19) United States
(12) Patent Application Publication
(10) Pub. No.: US 2022/0216526 A1
(43) Pub. Date: Jul. 7, 2022

(54) ELECTROLYTIC BATTERY FOR HIGH-VOLTAGE AND SCALABLE ENERGY STORAGE

(71) Applicant: THE UNIVERSITY OF ADELAIDE, South Australia (AU)

(72) Inventors: Dongliang CHAO, South Australia (AU); Shi-Zhang QIAO, South Australia (AU)

(73) Assignee: THE UNIVERSITY OF ADELAIDE, South Australia (AU)

(21) Appl. No.: 17/601,283

(22) PCT Filed: Apr. 3, 2020
(86) PCT No.: PCT/AU2020/050335

§ 371 Date: Oct. 4, 2021

(30) Foreign Application Priority Data
Apr. 5, 2019 (AU) 2019901177

(51) Int. Cl. H01M 10/36; H01M 10/26; H01M 4/80; H01M 4/66; H01M 4/24; H01M 4/50; H01M 4/42

(52) U.S. Cl. CPC H01M 10/36; H01M 10/26; H01M 4/808; H01M 2004/027; H01M 4/244; H01M 4/50; H01M 4/42; H01M 4/663

(57) ABSTRACT

A novel energy storage battery system is described that includes a highly reversible electrolytic Zn—MnO₂ system in which electrodeposition/electrolysis of Zn (anode side) and MnO₂ (cathode side) couple is employed with a theoretical voltage approximately 2 V and energy density of approximately 409 Wh kg⁻¹ providing superior durability and excellent energy densities.

### FIELD OF THE INVENTION

The field of the invention relates to rechargeable batteries and in particular rechargeable zinc-manganese dioxide (Zn—MnO₂) batteries that have increased output voltage and discharge capacity.

### BACKGROUND

There is a great deal of attention and interest in battery technology and development, and in particular in the development of scalable energy storage solutions that are economical to produce whilst also providing high capacity storage and efficient, reliable discharge with light weight so as to be able to address energy demands in current applications such as electric vehicles and green energy storage solutions.

Current battery types include lithium-ion battery, nickel batteries, and lead acid batteries, the latter of which has been around for quite some time.

Lead-acid batteries, for example, are relatively cheap to produce and incorporate lead plates in an acidic solution, widely used for storage in back-up power supplies in hospitals as well as for computer related equipment.

Lead acid batteries have significant drawbacks, not only in relation to their environmental impact using lead plates, which although may be recycled, are often discarded along with the highly corrosive sulphuric acid.

Lithium-ion batteries are often seen as a preferable alternative in terms of their long life due to their high charge density. Lithium-ion batteries use organic solution as electrolyte and are rechargeable. Such batteries are commonly used in the field of portable electronics however they have a limited rechargeable battery life (the number of full charge-discharge cycles before significant capacity loss) and are vulnerable to exothermic degradation reactions. Lithium-ion batteries may also experience thermal runaway events which can lead to cell rupture and in extreme cases leakage of the contents, which may present significant safety problems. Lithium-ion batteries are also relatively expensive with an approximate cost of US$300 per kWh (kilowatt hour). With lead acid batteries costing approximately US$48 per kWh, the lower cost is considered more commercially appealing, despite the drawbacks in limited storage and discharge capacity.

### SUMMARY OF THE INVENTION

In one aspect of the invention, although this should not be seen as limiting in any way, there is a rechargeable electrolytic zinc-manganese dioxide battery, including an anode, a cathode-less substrate and aqueous electrolyte containing zinc and manganese ions, and an acid, the aqueous electrolyte having a pH value less than 2.5.

In preference, the electrolyte includes sulphate ions.

In preference, the acid is H₂SO₄.

In preference, the anode is a zinc anode.

In preference, the zinc anode is a zinc foam anode.

In preference, the anode is made from at least one of carbon and/or pure zinc/zinc alloy.

In preference, the zinc is fabricated onto graphite foam to form the zinc foam anode.

In preference, the cathode-less substrate is selected from other suitable current collectors.

In preference, the cathode-less substrate is carbon.

In preference, the cathode-less substrate is carbon fibre cloth.

In preference, MnO₂ is deposited onto the cathode-less substrate after charging.

In preference, the pH of the electrolyte is controlled from 0-2.5.

In preference, the pH of the electrolyte is less than 2.0.

In preference, the pH of the electrolyte is 2.

In preference, the pH of the electrolyte is less than 1.5.

In preference, the electrolyte includes a soluble zinc salt and a soluble manganese salt.

In preference, the rechargeable zinc-manganese dioxide battery of the present invention is charged at a constant voltage.

In preference, the constant voltage is between approximately 2.00 V and 2.41 V.

A further form of the invention resides in a method of recharging an electrolytic zinc-manganese dioxide battery, including an anode, a cathode-less substrate and aqueous electrolyte containing zinc and manganese ions, the aqueous electrolyte having a pH value less than 2.5, wherein the battery is recharged at a constant voltage between approximately 2.00 V and 2.41 V.

### BRIEF DESCRIPTION OF THE DRAWINGS

By way of example, an embodiment of the invention is described with reference to the accompanying drawings, in which:

FIG. 1a is a schematic illustration and charge storage mechanism analysis of the battery in 1 M ZnSO₄+1 M MnSO₄ electrolyte (without H₂SO₄).

FIG. 1b is a schematic illustration of the charge storage mechanism of the electrolytic Zn—MnO₂ battery in 1 M ZnSO₄+1 M MnSO₄+H₂SO₄ electrolyte.

FIG. 2a is a graph of the change of pH values at differing cycles of the present invention in electrolyte without H₂SO₄;

FIG. 2b is a graph of the pH values of the electrolytes with changes in molarity of H₂SO₄ (x M H₂SO₄);

FIG. 2c is a graph of the galvanostatic discharge curves in the electrolytes with x M H₂SO₄;

FIG. 2d is a graph of the electrochemical stability in electrolytes with 0.1 M H₂SO₄, shows the preferred deposition voltages on a graph potential vs current.

FIG. 2e is a graph of the galvanostatic discharge curves at different rates from 2 to 60 mA cm⁻²;

FIG. 2f is the rate capability at different rate from 2 to 60 mA cm⁻². Inset shows the digital photograph of the home-made electrolysis cell.

FIG. 2g is a graph of the galvanostatic discharge curves for the first 50 cycles of the battery of the present invention with 0.1 M H₂SO₄;

FIG. 2h is cycling stability test at 30 mA cm⁻²;

FIG. 3 is a plot of various Zn-based batteries and their capacity vs voltage vs energy density.

### RESULTS

Charge storage mechanism in electrolytic zinc-manganese dioxide battery.

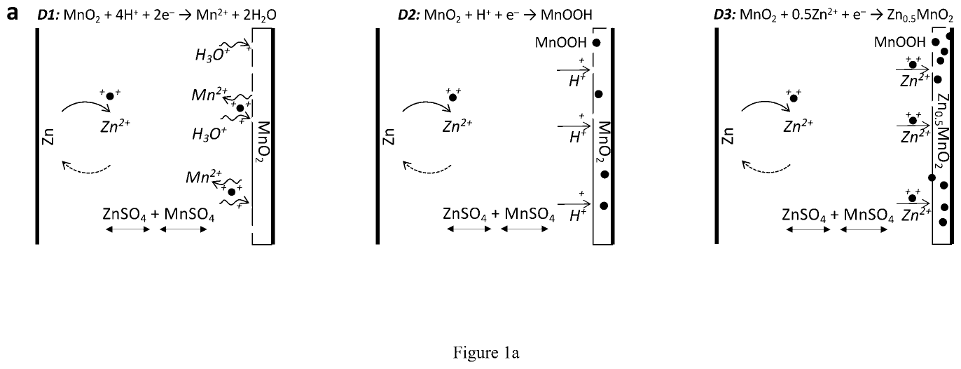

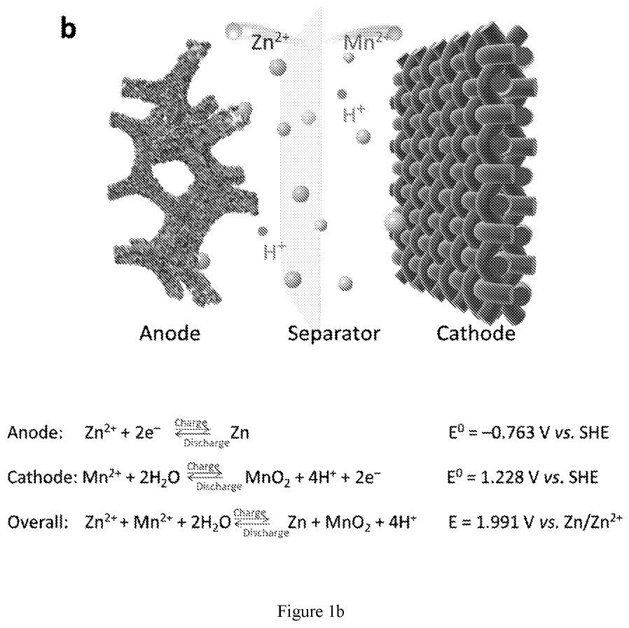

With reference to FIG. 1, the present invention is schematically illustrated as a result of chronoamperometric electrodeposition.

The cell of the present invention as shown in FIG. 1 is includes a Zn foam anode, glass fiber separator, cathode-less carbon fiber cloth, and ZnSO₄+MnSO₄ aqueous electrolyte for FIG. 1a and ZnSO₄+MnSO₄+H₂SO₄ aqueous electrolyte for FIG. 1b. Advantageously, ZnSO₄ and MnSO₄ are low cost, highly stable and soluble in water. Three-dimensional (3D) light-weight Zn foam is applied as a protype to replace a conventional compact Zn foil anode, in consideration of suppressing Zn dendrite, and improving Zn utilization and corresponding overall energy/power density.

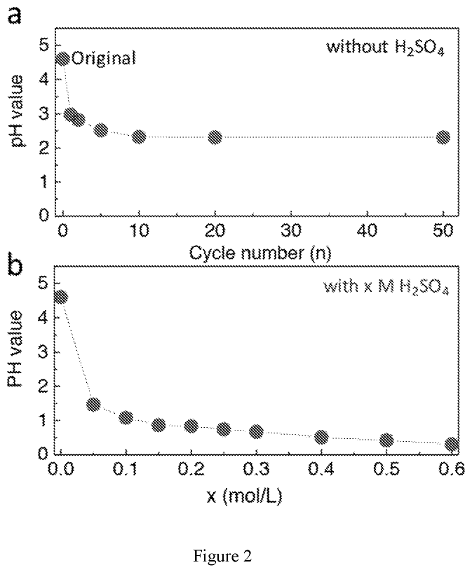

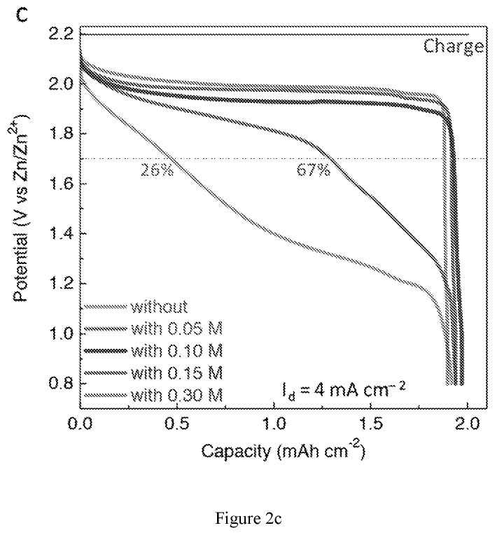

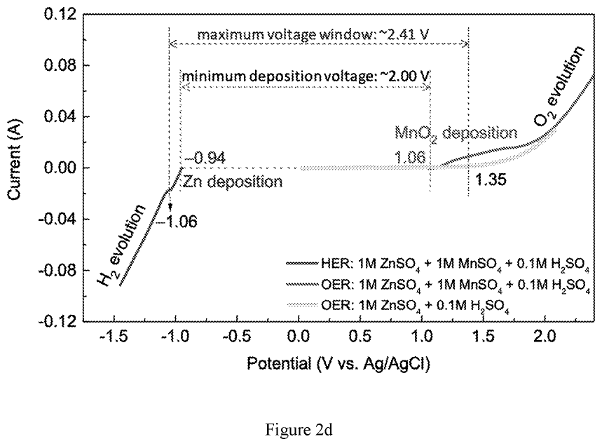

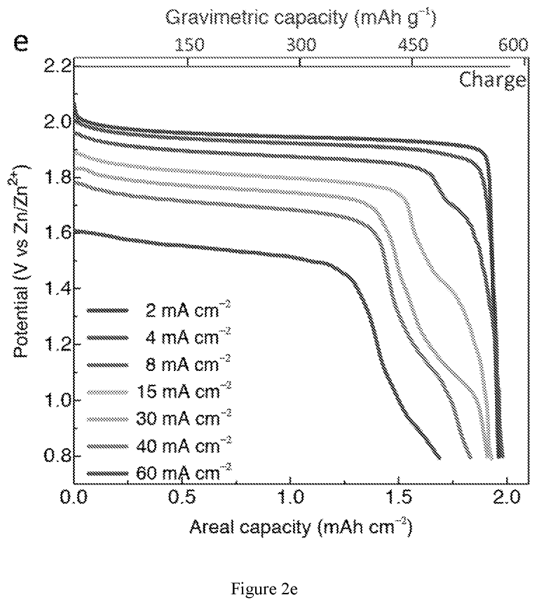

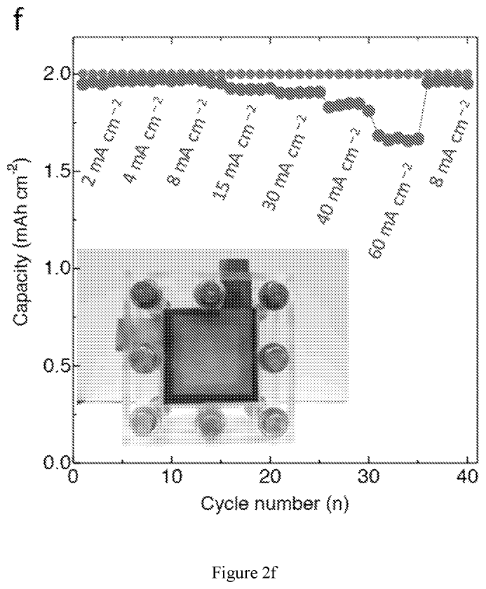

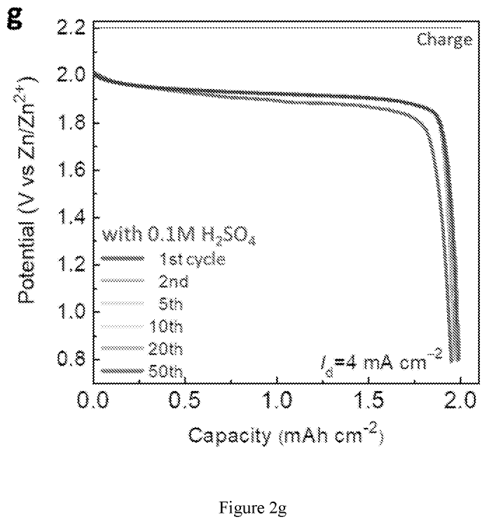

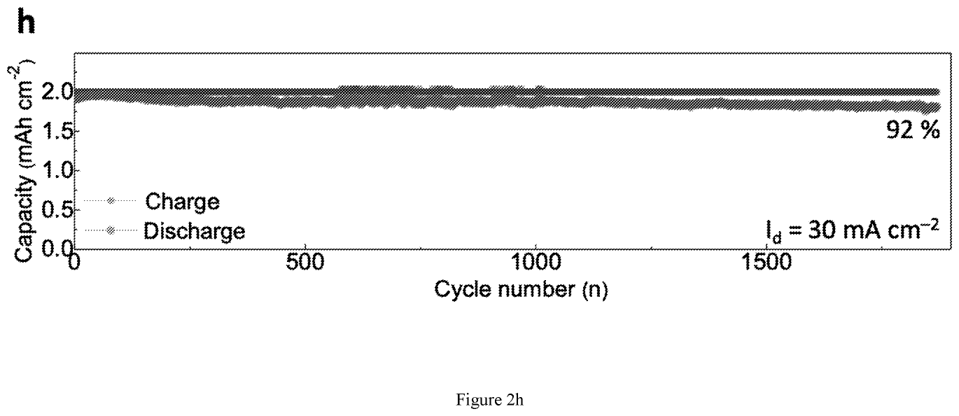

In the initial chronoamperometry charge process at 2.2 V as shown in FIG. 1, the Zn²⁺ and Mn²⁺ ions from the electrolyte solution are reduced to Zn on the anode and oxidized to form solid MnO₂ onto carbon fiber. This synthetic approach provides uniform and robust contact with substrates without use of binder or conductive additives. Multi redox reactions occurs in ZnSO₄+MnSO₄ aqueous electrolyte (without H₂SO₄) during the galvanostatic discharge process (see FIG. 1a). Referring to FIG. 2c, a discharge curve shows three main discharge regions, D1 (2.0-1.7 V), D2 (1.7-1.4 V), and D3 (1.4-0.8 V). The average discharge voltage plateau is only 1.4 V in the electrolyte without H₂SO₄.

Monitoring the pH values of the electrolyte in the above MnO₂ battery without H₂SO₄ are shown in FIG. 2a, and the pH values decrease as the increase of cycling number, i.e., from 4.60 at its original state to 2.32 after 10 cycles, and then stabilize at 2.30 after 20 cycles. Addition of H₂SO₄ simulates the effect of the increase in acidity in the electrolyte (see pH changes in FIG. 2b), in which a series of concentrations of H₂SO₄ was added into 1 M ZnSO₄ and 1 M MnSO₄ electrolyte directly (noted as x M H₂SO₄). The pH value drops dramatically from 4.60 without H₂SO₄ to 1.47 with 0.05 M H₂SO₄, and then decreases gradually to 0.67 and 0.31 with 0.30 and 0.60 M H₂SO₄ respectively. The corresponding galvanostatic discharge curves in FIG. 2c shows an intrinsic change in the capacity percentage of the high-voltage region D1, from 26% without H₂SO₄ to ˜67% with only 0.05 M H₂SO₄ and 100% with 0.10 M or higher concentration. Moreover, the discharge plateau keeps rising (see FIG. 2c and Table 1), benefiting from the higher electrolyte conductivity, increased protons concentration, and decreased electrochemical polarization at high acidity

TABLE 1
The discharge capacity, Coulombic efficiency, and average
discharge plateau of the electrolytic Zn—MnO₂ battery in
1M ZnSO₄, 1M MnSO₄, nd × M H₂SO₄ electrolyte.

| Electrolytic | | | | | |
|---|---|---|---|---|---|
| Zn—MnO₂ | without | 0.05M | 0.10M | 0.15M | 0.30M |
| battery | H₂SO₄ | H₂SO₄ | H₂SO₄ | H₂SO₄ | H₂SO₄ |
| Capacity | 1.92 | 1.94 | 1.97 | 1.94 | 1.89 |
| (mAh cm⁻²) | | | | | |
| Coulombic | 96.0% | 97.0% | 98.5% | 97.0% | 94.5% |
| efficiency | | | | | |
| High voltage | 26.0% | 67.0% | 98.5% | 98.9% | 99.4% |
| percentage | | | | | |
| (>1.7 V) | | | | | |
| Average plateau | 1.44 | 1.79 | 1.95 | 1.97 | 1.99 |
| (V) | | | | | |

Electrochemical stability tests of the Zn foam anode were performed and the electrolyte with 0.10 M H₂SO₄ shows superior stability and reversibility than ones with 0.15 and 0.30 M H₂SO₄ during Zn plating/stripping even at a high current of 20 mA cm⁻². As shown in FIG. 2d, the electrolyte with 0.10 M H₂SO₄ exhibits a wide electrochemical window and the parasitical H₂ (zinc anode) and O₂ (MnO₂ cathode) evolution reactions are significantly suppressed up to 1.06 V and 1.35 V vs. Ag/AgCl, respectively. The results indicate that a minimum deposition voltage of approximately 2.00 V is required for the simultaneous deposition of Zn and MnO₂. A maximum working voltage window of approximately 2.41 V was obtained within the H₂ and O₂ evolution potentials.

High-rate capability has been regarded as an important indicator for large scale application of batteries, such as fast-charging for electric vehicles and cell phones, and regenerative braking. The designed electrolytic Zn—MnO₂ battery of the present invention was then galvanostatically discharged at different current densities from 2 to 60 mA cm⁻² as shown in FIGS. 2e and 2f The discharge curves in the electrolyte with 0.10 M H₂SO₄ showed a typical battery behaviour with flat discharge plateaus of 1.95 V at 2 mA cm⁻² and 1.55 V even at 60 mA cm⁻² (in 100 s).

The discharge plateau and the acidity of the electrolyte are also proved stable along with the cycles (FIG. 2g). The discharge capacities retain higher than 1.96 mAh cm⁻² at 4 C (8 mA cm⁻²) and 1.67 mAh cm⁻² at 30 C (60 mA cm⁻²). The electrolytic Zn—MnO₂ battery of the present invention shows excellent cycling sustainability even at high rates. Around 92% of the maximum discharge capacity is maintained after 1800 cycles at 30 mA cm⁻² (FIG. 2h). This rate stability can be ascribed to the synergetic effects of the favourable and solo electrolysis reaction, higher electrolyte conductivity, smaller ohm and charge transfer resistances, and faster ion diffusion.

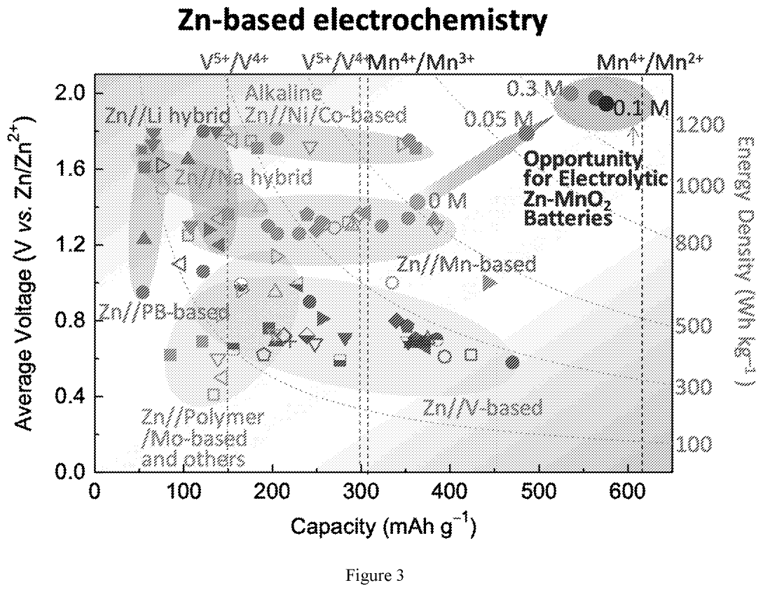

The gravimetric capacities of electrolytic Zn—MnO₂ batteries are shown in FIG. 3, which were calculated based on the deposited mass of MnO₂ after 10 cycles on carbon fiber cathode. The electrolytic ZnMnO₂ batteries of the present invention stand out in both the gravimetric capacities and the discharge plateaus. The gravimetric capacities of the MnO₂ ZIBs with 0 and 0.05 M H₂SO₄ are much lower than that of the electrolytic Zn—MnO₂ batteries (0.01-0.5 M) due to the presentence of both one- and two-electron reactions. The electrolytic Zn—MnO₂ battery of the present invention with 0.10 M H₂SO₄ exhibits the best gravimetric capacities as a result of high CE. As can be seen in FIG. 3, at 0 M H₂SO₄ the energy density of the battery of the present invention is approximately 500 Wh kg⁻¹. The energy density increases significantly at both 0.05 M and 0.1 M H₂SO₄. The electrolytic Zn—MnO₂ battery demonstrates unprecedented energy densities of 1100 Wh kg⁻¹ based on the active material mass of cathode, and 409 Wh kg⁻¹ when taking mass of Zn anode into consideration. These values correspond to at least 300% increase in the energy density compared with reported ZIBs.

The electrolytic Zn—MnO₂ battery of the present shows charging/discharging at an areal capacity up to 10 mAh cm⁻² with 96.0% CE and improvements such as increasing the thickness or surface area of the substrates can be used to further enhance the areal and volumetric behaviours. In further embodiments magnetic stirring or flowing design of the cell could be included. An electrolytic Zn—MnO₂ battery stack of the present invention with three cells in series connection was able to charge a cellphone (5 V, 5 W), after charging for only 60 s at 6.6 V with open-circuit potential of 6.24 V. The output voltage, energy efficiency, and cost of the electrolyte outperform conventional aqueous flow battery systems, such as Zn—Fe, Zn—Br₂, Zn—Ce, Zn-air, and all vanadium flow batteries. The electrolytic Zn—MnO₂ battery of the present invention exhibits excellent charge storage properties and high energy/power density which can meet the rapid power change from the grid.

The Zn—MnO₂ battery of the present invention uses low-cost electrolytic electrochemistry, and demonstrated outstanding properties, such as unprecedented voltage and capacity, as well as energy density compared with rechargeable known Zn-based batteries. The superior plateau performance is believed a result of both the improved proton reactivity and the cation vacancy activated MnO₂ in acidic electrolyte.

Methods

Materials. All reagents and materials in this work are all commercially available and used without further purification. Zinc sulfate monohydrate (ZnSO₄.H₂O, ≥99.0%), manganese sulfate monohydrate (MnSO₄.H₂O, ≥99.0%), sulfuric acid (H₂SO₄, 95.0-98.0%), sodium sulfate (Na₂SO₄, ≥99.0%), and boric acid (H₃BO₃, ≥99.5%) were purchased from Sigma-Aldrich.

Electrodeposition/electrolysis Zn—MnO₂ cell design. The Zn—MnO₂ aqueous batteries were assembled in the home-made electrolysis cell (see inset in FIG. 2f) using carbon fiber cloth as the cathode-less current collector and the Zn foam as the anode. 1 M ZnSO₄, 1 M MnSO₄ and x M H₂SO₄ solution was used as the electrolyte for electrolytic batteries. The carbon fiber cloth was treated hydrophilic by air plasma for 5 min before acting as a current collector. Zn foam anode was fabricated onto graphite foam via electrodeposition method with a solution with 2 g ZnSO₄.H₂O, 3 g Na₂SO₄, and 0.5 g H₃BO₃ dissolved in 20 mL DI water, and a constant current of 10 mA cm⁻² for 60 mins. The areal mass loading of the Zn foam was 3.6 mg cm⁻². The cathode and anode were sandwiched by glass fiber paper separator and assembled in a typical coin-cell stack. Ti/Cu foil was used as current collector for the electrodes, which was separated and not directly contacted with the electrolyte to avoid any side reactions.

Measurements

The chronoamperometry charge, galvanostatic discharge, cycling, and electrochemical impedance spectroscopy (EIS) measurements were recorded using LAND battery cycler (CT2001A), and IM6e potentiostat (Zahner Elektrik Co., Germany) at room temperature. The cell was charged at 2.2 V (vs. Zn/Zn²⁺) to 2 mAh cm⁻² with a constant-voltage technique to form uniform and mesoporous MnO₂ fluff. Then galvanostatic discharge at different current densities from 2-60 mA cm⁻² was applied with a cut off voltage of 0.8 V vs. Zn/Zn²⁺. The electrolytic Zn—MnO₂ single cell was performed in a two-electrode set-up, where Zn foam was applied as the anode and carbon fiber cloth for the cathode-less substrate.

The electrochemical stability and reversibility of electrolytes were tested in symmetrical Zn foam/Zn foil set-up in electrolyte with 0.10, 0.15 and 0.30 M H₂SO₄. The OER and HER tests were carried out in a three-electrode set-up with deposited MnO₂ as positive electrode, Ag/AgCl as the reference electrode, and Zn foam as the negative electrode. Liner sweep voltammetry was tested at 1 mV s⁻¹. The recorded areal capacities and current densities were calculated based on the geometric area of the deposited MnO₂. The reported gravimetric capacity was determined according to the mass of deposited MnO₂ active material. The energy and power densities were normalized to the total mass from both anode and cathode active materials.

1-18. (canceled)

19. A rechargeable electrolytic zinc-manganese dioxide battery, including an anode, a cathode-less substrate and aqueous electrolyte containing zinc and manganese ions, and an acid, the aqueous electrolyte having a pH value less than 2.5, wherein the rechargeable zinc-manganese dioxide battery is charged at a constant voltage, and wherein the constant voltage is between approximately 2.00 V and 2.41 V.

20. The rechargeable electrolytic zinc-manganese dioxide battery of claim 19, wherein the electrolyte includes sulphate ions.

21. The rechargeable electrolytic zinc-manganese dioxide battery of claim 19, wherein the acid is H₂SO₄.

22. The rechargeable electrolytic zinc-manganese dioxide battery of claim 19, wherein the anode is a zinc anode.

23. The rechargeable electrolytic zinc-manganese dioxide battery of claim 22, wherein the zinc anode is a zinc foam anode.

24. The rechargeable electrolytic zinc-manganese dioxide battery of claim 19, wherein the anode is made from at least one of carbon and/or pure zinc/zinc alloy.

25. The rechargeable electrolytic zinc-manganese dioxide battery of claim 23, wherein the zinc is fabricated onto graphite foam to form the zinc foam anode.

26. The rechargeable electrolytic zinc-manganese dioxide battery of claim 19, wherein the cathode-less substrate is selected from other suitable current collectors.

27. The rechargeable electrolytic zinc-manganese dioxide battery of claim 19, wherein the cathode-less substrate is carbon.

28. The rechargeable electrolytic zinc-manganese dioxide battery of claim 19, wherein the cathode-less substrate is carbon fibre cloth.

29. The rechargeable electrolytic zinc-manganese dioxide battery of claim 19, wherein MnO₂ is deposited onto the cathode-less substrate after charging.

30. The rechargeable electrolytic zinc-manganese dioxide battery of claim 19, wherein the pH of the electrolyte is controlled from 0-2.5.

31. The rechargeable electrolytic zinc-manganese dioxide battery of claim 30, wherein the pH of the electrolyte is less than 2.0.

32. The rechargeable electrolytic zinc-manganese dioxide battery of claim 30, wherein, the pH of the electrolyte is 2.

33. The rechargeable electrolytic zinc-manganese dioxide battery of claim 31, wherein the pH of the electrolyte is less than 1.5.

34. The rechargeable electrolytic zinc-manganese dioxide battery of claim 19, wherein the electrolyte includes a soluble zinc salt and a soluble manganese salt.

35. The rechargeable electrolytic zinc-manganese dioxide battery of claim 20, wherein the acid is H₂SO₄.

36. The rechargeable electrolytic zinc-manganese dioxide battery of claim 20, wherein the anode is a zinc anode.

37. The rechargeable electrolytic zinc-manganese dioxide battery of claim 21, wherein the anode is a zinc anode.

38. The rechargeable electrolytic zinc-manganese dioxide battery of claim 20, wherein the anode is made from at least one of carbon and/or pure zinc/zinc alloy.
